(19) United States
(12) Patent Application Publication
(10) Pub. No.: US 2026/0074432 A1
(43) Pub. Date: Mar. 12, 2026

(54) RADIO WAVE REFLECTIVE PLATE AND COMPOSITE RESONATOR

(71) Applicant: KYOCERA Corporation, Kyoto-shi, Kyoto (JP)

(72) Inventors: Masamichi YONEHARA, Yokohama-shi, Kanagawa (JP); Hiromichi YOSHIKAWA, Yokohama-shi, Kanagawa (JP)

(21) Appl. No.: 19/105,550

(22) PCT Filed: Aug. 8, 2023
(86) PCT No.: PCT/JP2023/028878

§ 371 Date: Feb. 21, 2025

(30) Foreign Application Priority Data
Aug. 25, 2022 (JP) 2022-134374

(51) Int. Cl. H01Q 15/14

(52) U.S. Cl. CPC H01Q 15/14

(57) ABSTRACT

A radio wave reflective plate includes a plurality of unit structures arrayed in a first plane direction and a reference conductor that is subjected to a reference potential of the plurality of unit structures. The plurality of unit structures are represented by an equivalent circuit including two or more resonant circuits. The reference conductor is disposed below a resonator in a first direction.

### TECHNICAL FIELD

The present disclosure relates to a radio wave reflective plate and a composite resonator.

### BACKGROUND OF INVENTION

A known technique includes controlling electromagnetic waves without using a dielectric lens. For example, Patent Document 1 describes a technique of refracting radio waves in a structure including an array of resonator elements by changing parameters of the respective resonator elements.

### CITATION LIST

### Patent Literature

Patent Document 1: JP 2015-231182 A

### SUMMARY

A radio wave reflective plate of the present disclosure includes a plurality of unit structures and a reference conductor. The plurality of unit structures are arrayed in a first plane direction. The reference conductor is subjected to a reference potential of the plurality of unit structures. The plurality of unit structures are represented by an equivalent circuit including two or more resonant circuits. The reference conductor is disposed below a resonator in a first direction.

A radio wave reflective plate of the present disclosure includes a plurality of unit structures and a reference conductor. The plurality of unit structures are arrayed in a first plane direction. The reference conductor is subjected to a reference potential of the plurality of unit structures. The plurality of unit structures each include two or more resonators expanding in a first direction and a connector including the reference conductor between the two or more resonators, the connector being configured to magnetically or capacitively connect the two or more resonators. The reference conductor is disposed below the two or more resonators in the first direction.

A radio wave reflective plate of the present disclosure includes a plurality of unit structures and a reference conductor. The plurality of unit structures are arrayed in a first plane direction. The reference conductor is subjected to a reference potential of the plurality of unit structures. The plurality of unit structures each include a first resonator expanding in the first plane direction, a second resonator away from the first resonator in a first direction and expanding in the first plane direction, and a connector configured to magnetically or capacitively connect the first resonator and the second resonator in the first direction. The reference conductor is disposed below the first resonator and the second resonator in the first direction.

A radio wave reflective plate of the present disclosure includes a plurality of unit structures, a reference conductor, and a first resonator. The plurality of unit structures are arrayed in a first plane direction. The reference conductor is entirely connected across the plurality of unit structures and is subjected to a reference potential. The first resonator inputs and outputs electromagnetic waves from and to a free space and is coupled to the electromagnetic waves. The first resonator is electromagnetically coupled to a third resonator group including one or more resonators disposed in a layering direction. Main coupling is dependently made between the resonators. The resonators are represented by an equivalent circuit in which coupling is made and frequency is adjusted by the reference conductor. The reference conductor is disposed below the first resonator in a first direction.

A composite resonator of the present disclosure is represented by an equivalent circuit including two or more resonant circuits, and a reference conductor is disposed below a resonator in a first direction.

A composite resonator of the present disclosure includes two or more resonators expanding in a first direction and a connector including a reference conductor between the two or more resonators, the connector being configured to magnetically or capacitively connect the two or more resonators. The reference conductor is disposed below a resonator in the first direction.

A composite resonator of the present disclosure includes a first resonator, a second resonator, a connector, and a reference conductor. The first resonator expands in the first plane direction. The second resonator is away from the first resonator in a first direction and expands in the first plane direction. The connector magnetically or capacitively connects the first resonator and the second resonator in the first direction. The reference conductor is disposed below the first resonator and the second resonator in the first direction.

A composite resonator of the present disclosure includes a first resonator configured to input and output electromagnetic waves from and to a free space and to be coupled to the electromagnetic waves. The first resonator is electromagnetically coupled to a third resonator group including one or more resonators disposed in a layering direction. Main coupling is dependently made between the resonators. The resonators are represented by an equivalent circuit in which coupling is made and frequency is adjusted by a reference conductor. The reference conductor is disposed below the first resonator in a first direction.

### BRIEF DESCRIPTION OF THE DRAWINGS

FIG. 1 is a diagram illustrating an overview of a radio wave reflective plate according to an embodiment.

FIG. 2 is a diagram illustrating a configuration example of a unit structure according to the embodiment.

FIG. 3 is a diagram illustrating a configuration example of a coupling conductor according to the embodiment.

FIG. 4 is a diagram showing an example of phase characteristics of a unit structure according to a comparative example.

FIG. 5 is a diagram showing an example of phase characteristics of a unit structure of a first example according to the embodiment.

FIG. 6 is a diagram showing an example of phase characteristics of a unit structure of a second example according to the embodiment.

### DESCRIPTION OF EMBODIMENTS

In the following, embodiments of the present invention will be described in detail with reference to the accompanying drawings. The present invention is not limited by the embodiments, and in the following embodiments, the same reference signs are assigned to the same portions and redundant descriptions thereof will be omitted.

In the following description, an XYZ orthogonal coordinate system is set, and the positional relationship between respective portions will be described by referring to the XYZ orthogonal coordinate system. A direction parallel to an X axis in a horizontal plane is defined as an X axis direction, a direction parallel to a Y axis orthogonal to the X axis in the horizontal plane is defined as a Y axis direction, and a direction parallel to a Z axis orthogonal to the horizontal plane is defined as a Z axis direction. A plane including the X-axis and the Y-axis is appropriately referred to as an XY plane, a plane including the X-axis and the Z-axis is appropriately referred to as an XZ plane, and a plane including the Y-axis and the Z-axis is appropriately referred to as a YZ plane. The XY plane is parallel to the horizontal plane. The XY plane, the XZ plane, and the YZ plane are orthogonal to each other.

### Embodiment

### Radio Wave Reflective Plate

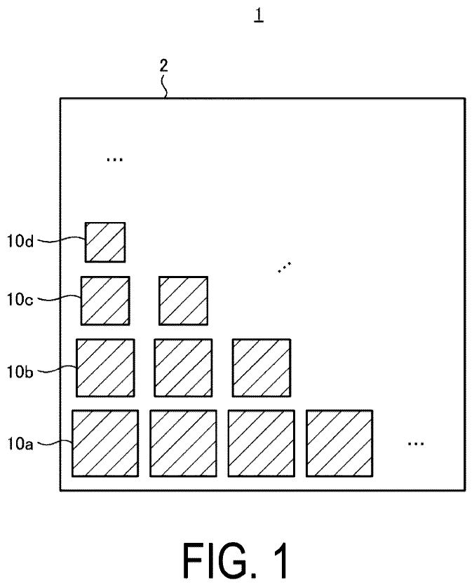

An overview of a radio wave reflective plate according to an embodiment will be described with reference to FIG. 1. FIG. 1 is a diagram illustrating the overview of the radio wave reflective plate according to the embodiment.

A radio wave reflective plate 1 is a plate-shaped member configured to be transmissive to a radio wave transmitted from a base station. For example, the radio wave reflective plate 1 is configured to, upon receipt of the radio wave transmitted from the base station, reflect a radio wave at a predetermined angle and emit a reflected radio wave. The radio wave reflective plate 1 may be made of, for example, a metamaterial that changes a phase of an incident wave.

As illustrated in FIG. 1, the radio wave reflective plate 1 may include a substrate 2, unit structures 10a, unit structures 10b, unit structures 10c, and unit structures 10d.

The unit structures 10a, the unit structures 10b, the unit structures 10c, and the unit structures 10d may be formed on the substrate 2. The substrate 2 may have a rectangular shape, for example, but is not limited thereto. The unit structures 10a, the unit structures 10b, the unit structures 10c, and the unit structure 10d may be two dimensionally arrayed on the substrate 2. The substrate 2 may be, for example, a dielectric substrate made of a dielectric body.

Specifically, on the substrate 2, a plurality of unit structures 10a may be arranged, in an example, in the bottom row of the substrate 2. On the substrate 2, a plurality of unit structures 10b may be arranged in a line above the row where the unit structures 10a are arranged. On the substrate 2, a plurality of unit structures 10c may be arranged in a line above the row where the unit structures 10b are arranged. On the substrate 2, a plurality of unit structures 10d may be arranged in a line above the row where the unit structures 10c are arranged. That is, the radio wave reflective plate 1 may have a structure in which a plurality of unit structures having different sizes are periodically arrayed. The unit structures 10a to 10d may be different from each other in a frequency band and a change amount in a phase of the radio wave to be changed. The unit structures 10a to 10d have the rectangular shapes, without limitation. The frequency band and the change amount in a phase of the radio wave to be reflected can be adjusted by varying the sizes and shapes of the unit structure 10a, the unit structure 10b, the unit structure 10c, and the unit structure 10d.

### Configuration of Unit Structure

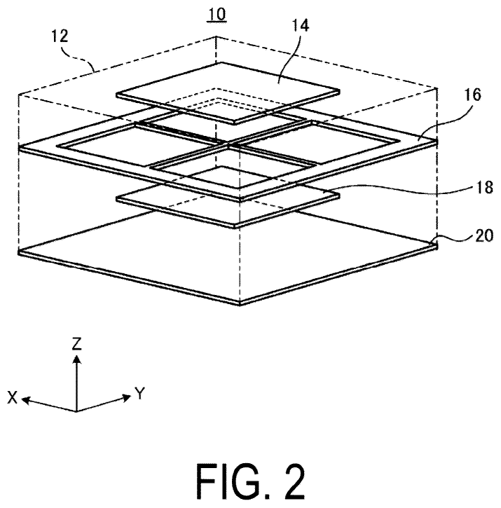

A configuration example of a unit structure according to the embodiment will be described with reference to FIG. 2. FIG. 2 is a diagram illustrating the configuration example of the unit structure according to the embodiment.

As illustrated in FIG. 2, a unit structure 10 includes a substrate 12, a first resonator 14, a coupling conductor 16, a second resonator 18, and a reflective conductor (reference conductor) 20. The unit structure 10 has a four layer structure in which four layers of conductors are layered. In the unit structure 10, the reflective conductor 20, the second resonator 18, the coupling conductor 16, and the first resonator 14 are layered in this order from the bottom.

The first resonator 14 is formed in the uppermost layer. The first resonator 14 expands on the XY plane. The first resonator 14 may be, for example, a patch conductor formed in a rectangular shape, but the present disclosure is not limited thereto. The first resonator 14 may have, for example, a linear shape, a circular shape, a loop shape, or a polygonal shape other than a rectangular shape. The shape of the first resonator 14 may be optionally changed according to a design. The first resonator 14 resonates with electromagnetic waves received from the +Z-axis direction. The first resonator 14 is not in contact with the end portion of the substrate 12. The size of the first resonator 14 may be optionally changed according to the design.

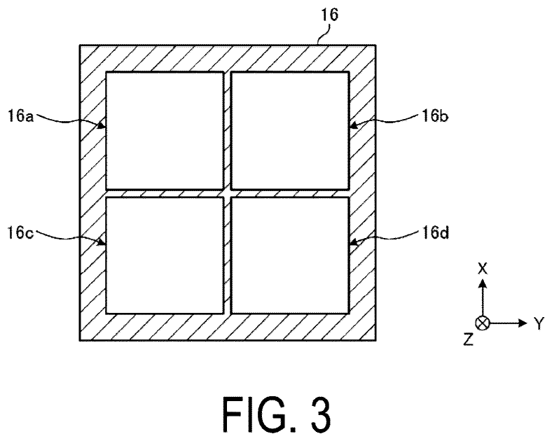

The coupling conductor 16 is formed in a layer immediately below the layer in which the first resonator 14 is formed. FIG. 3 is a diagram illustrating a configuration example of the coupling conductor 16 according to the embodiment. As illustrated in FIG. 3, the coupling conductor 16 expands on the XY plane. The coupling conductor 16 is configured in a square shape. The coupling conductor 16 includes a hole portion 16a, a hole portion 16b, a hole portion 16c, and a hole portion 16d. The hole portion 16a is formed, for example, at the upper left corner of the coupling conductor 16. The hole portion 16b is formed, for example, at the upper right corner of the coupling conductor 16. The hole portion 16c is formed, for example, at the lower left corner of the coupling conductor 16. The hole portion 16d is formed, for example, at the lower right corner of the coupling conductor 16. The hole portion 16a, the hole portion 16b, the hole portion 16c, and the hole portion 16d may be formed in the same square shape, for example. That is, the coupling conductor 16 includes the hole portion 16a to the hole 16d formed to have four-fold rotational symmetry. The size of each of the hole portion 16a to the hole portion 16d may be optionally changed according to the design. The coupling conductor 16 is also referred to as a connector in order to capacitively or magnetically connect the first resonator 14 and the second resonator 18 to each other.

The second resonator 18 is formed in a layer immediately below the layer in which the coupling conductor 16 is formed. The second resonator 18 expands on the XY plane. The second resonator 18 may be, for example, a patch conductor formed in a rectangular shape, but the present disclosure is not limited thereto. The second resonator 18 may have, for example, a linear shape, a circular shape, a loop shape, or a polygonal shape other than a rectangular shape. The shape of the second resonator 18 may be optionally changed according to a design. The second resonator 18 resonates with electromagnetic waves received from the +Z-axis direction. The second resonator 18 is not in contact with the end portion of the substrate 12. The size of the second resonator 18 may be optionally changed according to the design. The first resonator 14 and the second resonator 18 may be different from each other in the shape and the size. The first resonator 14 and the second resonator 18 are capacitively or magnetically connected to each other via the hole portions 16a to 16d of the coupling conductor 16.

The reflective conductor 20 is formed over the entire surface of the XY plane on the substrate 2. The reflective conductor 20 is disposed on the lowermost surface of the unit structure 10. The reflective conductor 20 includes a conductor. The reflective conductor 20 is configured as a reference conductor (ground conductor). The reflective conductor 20, for example, reflect electromagnetic waves received from the +Z-axis direction to the +Z-axis direction. Note that the reflective conductor 20 is not limited to being formed over the entire surface of the XY plane. The reflective conductor 20 may be, for example, sufficiently large with respect to a wavelength of the received radio wave.

That is, the unit structure 10 may be represented by an equivalent circuit including two LC resonant circuits. For example, the unit structure 10 may have a configuration represented by an equivalent circuit including two or more LC resonant circuits. In other words, the unit structure 10 may include two or more resonators. In this case, the coupling conductor 16 is located between the respective resonators. In this case, the coupling conductor 16 magnetically or capacitively connects the respective resonators.

It can be said that the first resonator 14 of the unit structure 10 is a resonator configured to input and output electromagnetic waves from and to a free space and to be coupled to the electromagnetic waves. The first resonator 14 may be electromagnetically coupled to a third resonator group including one or more resonators disposed in the Z direction (layering direction). The main coupling between the plurality of resonators may be dependently made between the resonators. In this case, the plurality of resonators can be represented by an equivalent circuit in which coupling and frequency adjustment are performed by the reflective conductor 20 (reference conductor).

### Frequency Characteristic

### Comparative Example

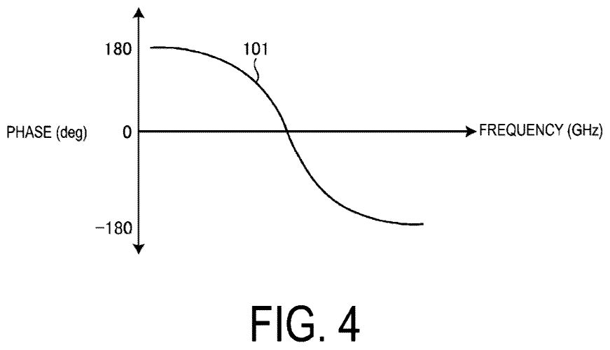

Phase characteristics of the unit structure according to a comparative example will be described with reference to FIG. 4. FIG. 4 is a diagram showing an example of phase characteristics of a unit structure according to the comparative example. The unit structure of the comparative example has, for example, a so-called mushroom structure in which a ground substrate and one metal plate are electromagnetically connected to each other by a via.

In FIG. 4, the horizontal axis represents the frequency [gigahertz (GHz)], and the vertical axis represents the phase [deg]. A curve 101 in a graph of FIG. 4 shows a relationship between the frequency and the phase. As shown in the graph 101, the unit structure according to the comparative example has nonlinear characteristics with respect to the frequency. For this reason, the unit structure according to the comparative example is configured to target only a specific frequency, and it is difficult to maintain characteristics over a wide band.

### Embodiments

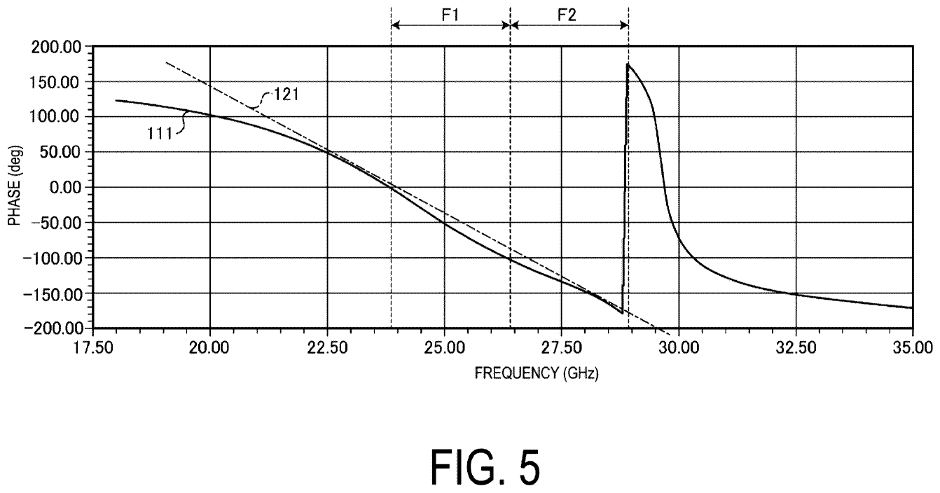

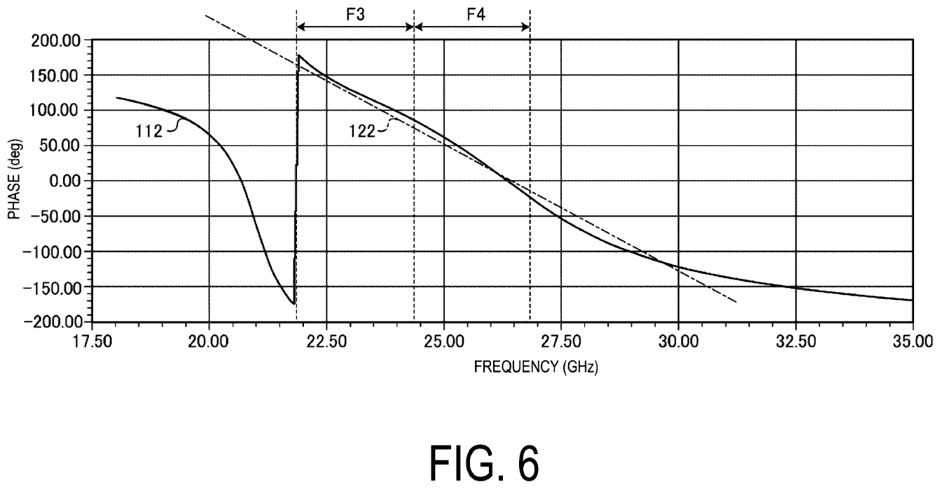

Phase characteristics of the unit structure according to the embodiment will be described with reference to FIGS. 5 and 6. FIG. 5 is a diagram showing an example of a phase characteristics of a unit structure of a first example according to the embodiment. FIG. 6 is a diagram showing an example of phase characteristics of a unit structure of a second example according to the embodiment.

In FIG. 5, the horizontal axis represents the frequency [GHz], and the vertical axis represents the phase [deg]. A curve 111 in a graph of FIG. 5 shows a relationship between the frequency and the phase. A line 121 in the graph is an approximate straight line of the curve 111 in the graph. That is, in the unit structure 10 according to the embodiment, the relationship between the frequency and the phase exhibits linear characteristics in a specific frequency band. For example, in the unit structure 10 according to the embodiment, the relationship between the frequency and the phase exhibits the linear characteristics in a frequency band F1 and a frequency band F2. The frequency band F1 is, for example, a band from about 24.00 GHz to about 26.50 GHz. The frequency band F2 is, for example, a region from 26.50 GHz to about 29.00 GHz. The frequency band F1 and the frequency band F2 each have a bandwidth of 2.5 GHz. As shown with the curve 111 in the graph, in the unit structure 10 according to the embodiment, for example, the frequency and the phase exhibit the linear characteristics in the frequency band F1 and the frequency band F2. Specifically, in the unit structure 10 according to the embodiment, the frequency and the phase exhibit the linear characteristics in a phase range of from about −180° to about +50°. As a result, in the unit structure 10 according to the embodiment, the influence of the shift of the frequency on the phase in the frequency band F1 and the frequency band F2 can be reduced, and thus the characteristics of the unit structure 10 can be stabilized over a wide band. In the present disclosure, by changing the design of the unit structure 10, a region where the frequency and the phase exhibit the linear characteristics can be changed.

FIG. 6 shows an example of phase characteristics of the unit structure different from that shown in FIG. 5. In FIG. 6, the horizontal axis represents the frequency [GHz], and the vertical axis represents the phase [deg]. A curve 112 in a graph of FIG. 6 shows a relationship between the frequency and the phase. A curve 122 in the graph is an approximate curve of the curve 112 in the graph. For example, in the unit structure 10 according to the embodiment, the relationship between the frequency and the phase exhibits the linear characteristics in a frequency band F3 and a frequency band F4. The frequency band F3 is, for example, a band from about 22.00 GHz to about 24.50 GHz. The frequency band F2 is, for example, a region from 24.50 GHz to about 27.00 GHz. The frequency band F3 and the frequency band F3 each have a bandwidth of 2.5 GHz. That is, the frequency band F3 and the frequency band F4 are different from the frequency band F1 and the frequency band F2 shown in FIG. 5, respectively. As indicated by the curve 112 in the graph, in the unit structure 10 in the example shown in FIG. 6, the frequency and the phase exhibits the linear characteristics in the frequency band F3 and the frequency band F4. Specifically, in the unit structure 10 in the example shown in FIG. 6, the frequency and the phase exhibits the linear characteristics in a range of from about −100° to about +180°. In the unit structure 10 in the example shown in FIG. 5, the influence of the shift of the frequency on the phase in the frequency band F3 and the frequency band F4 can be reduced, and thus the characteristics of the unit structure 10 can be stabilized over a wide band.

As shown in FIGS. 5 and 6, in the unit structure 10, the region where the relationship between the frequency and the phase exhibits the linear characteristics can be changed by changing the design. For example, in the present disclosure, the unit structure having the linear phase characteristics over a wide range such as from −180° to +180° can be achieved.

Embodiments of the present disclosure have been described above, but the present disclosure is not limited by the contents of the embodiments. Constituent elements described above include those that can be easily assumed by a person skilled in the art, those that are substantially identical to the constituent elements, and those within a so-called range of equivalency. The constituent elements described above can be combined as appropriate. Various omissions, substitutions, or modifications of the constituent elements can be made without departing from the spirit of the above-described embodiments.

### REFERENCE SIGNS

1 Radio wave reflective plate
2, 12 Substrate
10 Unit structure
14 First resonator
16 Coupling conductor
18 Second resonator
20 Reflective conductor

1.-6. (canceled)

7.

7. A composite resonator comprising:
a first resonator expanding in a first plane direction;
a second resonator disposed below the first resonator in the first direction and expanding in the first plane direction;
a connector disposed between the first resonator and the second resonator in the first direction and configured to magnetically or capacitively connect the first resonator and the second resonator; and
a reference conductor disposed below the second resonator in the first direction.

8. (canceled)

9. A composite resonator according to claim 7, wherein
the connector includes a hole portion.

10. A composite resonator according to claim 9, wherein
the connector includes four of the hole portion.

11. A composite resonator according to claim 7, wherein
the hole portion is formed so that the connecter has four-fold rotational symmetry.

12. A radio wave reflective plate comprising:
plurality of composite resonators according claim 7 are arranged on the first surface.
